(19) United States
(12) Patent Application Publication
(10) Pub. No.: US 2025/0231128 A1
(43) Pub. Date: Jul. 17, 2025

(54) SYSTEMS AND METHODS FOR MAPPING IRREGULAR SURFACES

(71) Applicant: IXRF, Inc., Austin, TX (US)

(72) Inventors: Robert Tisdale, Austin, TX (US); Nathan Stoddard, Kyle, TX (US); Frank Swehosky, Spicewood, TX (US)

(73) Assignee: IXRF, Inc., Austin, TX (US)

(21) Appl. No.: 19/020,604

(22) Filed: Jan. 14, 2025

Related U.S. Application Data
(60) Provisional application No. 63/621,420, filed on Jan. 16, 2024.

(51) Int. Cl. G01N 23/223; B25J 18/00; G01N 23/2204

(52) U.S. Cl. CPC G01N 23/223; B25J 18/00; G01N 23/2204; G01N 2223/3303; G01N 2223/3307

(57) ABSTRACT

In some embodiments, a spectrometer analysis system may include a spectrometer having an X-ray assembly with one or more X-ray sources and one or more X-ray detectors. The spectrometer may have an electronic evaluation unit communicatively coupled to the X-ray assembly. The spectrometer analysis system may include a computing device communicatively coupled to the X-ray assembly and the electronic evaluation unit. The computing device may be configured to compare at least one of a plurality of features of a pixel spectrum received at a first time to at least one of the plurality of features of the pixel spectrum received at a second time. The spectrometer analysis system may include one or more motors communicatively coupled to the computing device and configured to adjust a distance between a sample and the spectrometer based at least in part on the comparing by the computing device.

### CROSS-REFERENCE TO RELATED APPLICATIONS

This application claims the benefit of priority under 35 U.S.C. § 119(e) to prior U.S. Provisional Patent Application No. 63/621,420 filed on Jan. 16, 2024, the disclosure of which is incorporated by reference herein in its entirety.

### FIELD OF DISCLOSURE

The disclosed systems and methods relate to the field of elemental analysis. More particularly, the disclosed systems and methods are directed to X-ray fluorescence (XRF) elemental analysis, imaging, and mapping spectrometric measurements of irregular surfaces.

### BACKGROUND

XRF measurement is used in materials analysis. XRF is a technique for determining the elemental composition and other properties, such as thickness, of a sample. XRF analyzers include an X-ray source, which irradiates the sample with sufficient energy to excite X-ray fluorescence from the elements of interest within the sample. XRF analyzers also include an X-ray detector for detecting the X-ray fluorescence emitted by the sample in response to the irradiation. Each element in the sample emits X-ray fluorescence at discrete energies that are characteristic of the element. The detected X-ray fluorescence is analyzed to find the energies or the wavelengths of the detected photons, and the number of emitted photons (i.e., intensity) as a function of energy or wavelength. The detected X-ray fluorescence can also determine the qualitative composition, quantitative composition, thickness, and other properties of the sample. Conventional XRF systems typically analyze a sample using a spectrometer at a fixed distance from the sample.

### SUMMARY

In some embodiments, a spectrometer analysis system may include a spectrometer having an X-ray assembly with one or more X-ray sources and one or more X-ray detectors. The spectrometer may have an electronic evaluation unit communicatively coupled to the X-ray assembly. The electronic evaluation unit may be configured to digitize electrical signals of a plurality of X-rays received by the one or more X-ray detectors. The electronic evaluation unit may be configured to determine a pixel spectrum having a plurality of features. The spectrometer analysis system may include a computing device communicatively coupled to the X-ray assembly and the electronic evaluation unit. The computing device may be configured to compare at least one of the plurality of features of the pixel spectrum received at a first time to at least one of the plurality of features of the pixel spectrum received at a second time. The spectrometer analysis system may include one or more motors communicatively coupled to the computing device and configured to adjust a distance between a sample and the spectrometer based at least in part on the comparing by the computing device.

In some embodiments, the one or more motors may be further configured to move at least one of the sample or the spectrometer in an X-direction and a Y-direction. In some embodiments, the spectrometer may be coupled to a Z-stage configured to move in a Z-direction. In some embodiments, the sample may be coupled to at least one Z-stage configured to move in a Z-direction. In some embodiments, the distance between the sample and the spectrometer may be in a Z-direction. In some embodiments, a scanning modality of the spectrometer or the sample is in one of a raster, a sinusoidal, a rotational, a spiral, a cycloid, or a Lissajous pattern. In some embodiments, the spectrometer is coupled to a robotic arm. In some embodiments, the spectrometer analysis system may include one or more position sensors configured to provide a signal used by the one or more motors to maintain a consistent distance between the spectrometer and the sample.

In some embodiments, a method of XRF analysis may include exciting a sample by at least one X-ray source. The excitation of the sample may cause the sample to emit X-rays. The method may include detecting a plurality of X-rays by at least one X-ray detector. The method may include digitizing electrical signals corresponding to the plurality of detected X-rays by a digital pulse processor. The method may include determining a pixel spectrum from the digitized electrical signals by a multichannel analyzer. The pixel spectrum may have a plurality of features. The method may include comparing, by a computing device, at least one of the plurality of features of the pixel spectrum received at a first time to at least one of the plurality of features of the pixel spectrum received at a second time. The method may include based at least in part on the comparing by the computing device, adjusting a distance between a spectrometer and the sample.

In some embodiments, the method may include adjusting at least one of the spectrometer or the sample in an X-direction or a Y-direction. The distance between the spectrometer and the sample may be in a Z-direction. In some embodiments, the method may include moving the spectrometer or the sample in an angular direction. In some embodiments, the movement of the spectrometer or the sample may be in one of a raster, a sinusoidal, a rotational, a spiral, a cycloid, or a Lissajous pattern. In some embodiments, the adjustment of the distance between the spectrometer and the sample may be facilitated by one or more position sensors configured to provide a signal used by one or more motors to maintain a consistent distance between the spectrometer and the sample. In some embodiments, the spectrometer or the sample may be coupled to one or more Z-stages or a robotic arm.

In some embodiments, a non-transitory computer readable medium may have instructions stored thereon, wherein the instructions, when executed by at least one processor, may cause a computing device to perform operations including energizing at least one X-ray source to excite a sample. The excitation of the sample may cause the sample to emit X-rays. The operations may include digitizing electrical signals corresponding to a plurality of detected X-rays by a digital pulse processor. The operations may include determining a pixel spectrum from the digitized electrical signals by a multichannel analyzer. The pixel spectrum may have a plurality of features. The operations may include comparing at least one of the plurality of features of the pixel spectrum received at a first time to at least one of the plurality of features of the pixel spectrum received at a second time. The operations may include based at least in part on the comparison of the least one of the plurality of features at the first time and the second time, adjusting a distance between the sample and a spectrometer.

In some embodiments, the operations may include adjusting at least one of the spectrometer or the sample in an X-direction or a Y-direction. The distance between the spectrometer and the sample may be in a Z-direction. In some embodiments, the operations may include moving the spectrometer or the sample in an angular direction. In some embodiments, the movement of the spectrometer or the sample may be in one of a raster, a sinusoidal, a rotational, a spiral, a cycloid, or a Lissajous pattern. In some embodiments, the adjustment of the distance between the spectrometer and the sample may be facilitated by one or more position sensors configured to provide a signal used by one or more motors to maintain a consistent distance between the spectrometer and the sample. In some embodiments, the spectrometer or the sample may be coupled to one or more Z-stages or a robotic arm.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates one example of an XRF spectrometer system with a spectrometer mounted to a Cartesian geometry set of stages in accordance with some embodiments;

FIG. 2 illustrates one example of an XRF spectrometer system with a sample mounted to a set of stages in accordance with some embodiments;

FIG. 3 illustrates one example of an XRF spectrometer system with a spectrometer incorporating a multi-axis industrial robot in accordance with some embodiments;

FIG. 4 illustrates aspects of an exemplary spectrometer in accordance with some embodiments;

FIG. 5 illustrates one example of a block diagram of an exemplary XRF spectrometer analysis system configured to maintain a constant distance between a sample surface and a spectrometer in accordance with some embodiments;

FIG. 6 illustrates one example of a plot of a pixel spectrum after analysis by an XRF spectrometer system in accordance with some embodiments;

FIG. 7 illustrates one example of a block diagram of an exemplary computing device in accordance with some embodiments;

FIG. 8 illustrates a block diagram of an exemplary method of XRF analysis in accordance with some embodiments; and

FIG. 9 illustrates a block diagram of exemplary operations of XRF analysis in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure is directed to systems and methods for XRF elemental analysis, imaging, and mapping. The systems and methods disclosed herein may control the distance between the X-ray source and detector assembly (e.g., the spectrometer), and the surface relief or surface features of a sample. The present disclosure may use various features of spectrometric data from the XRF spectrometer to continuously adjust the spectrometer to sample distance to achieve a constant illumination point (or focal point) size and distance.

For example, systems and methods disclosed herein allow for mapping spectrometric measurements of non-planar samples and specimens with higher topography. Meso-XRF (e.g., from 1 mm in beam diameter) and micro-XRF (e.g., down to a few microns in beam diameter) spectrometer systems may be coupled with Cartesian geometry motorized high-precision stages (XY or XYZ, where Z is the distance from the X-ray source) that move the X-ray beam in a scanning pattern, such as by moving the sample, spectrometer, or both. By stepping or slewing the sample and/or spectrometer in a controlled way, multiple XRF spectra may be accumulated. In this type of analysis, each spectrum may be assigned to a specific pixel so as to form a two-dimensional (2D) map or image of a measured area. In this way, a data cube of 2D locations and their associated spectra are collected. Multiple map images of a sample, or portion of a sample, may be displayed on an element-by-element basis with different faux coloration per element. Colors may be assigned such that each element is identified by a specific color and a brighter color is typically indicative of higher concentration of any given element.

In some embodiments, a system is provided for maintaining a constant distance between a sample surface and the spectrometer. For example, the system may include: (1) one or more X-ray sources and one or more X-ray detector assemblies, which are configured to provide raw energy dispersive XRF spectral information, on a per-pixel basis; (2) an electronic evaluation unit having one or more digital pulse processors (DPP), which may be configured to digitize electrical signals from the detector, and one or more multichannel analyzer(s) (MCA), which may be configured to categorize the energy of X-rays detected by the detector(s) resulting in an output of counts (intensity) by X-ray energy by pixel; (3) a computing device, which may be configured to compare aspects or features of the most current pixel spectra to those same aspects or features in immediately previous pixel spectra, or averaged and/or normalized groups of previous pixel spectra to determine if the sample to spectrometer distance is increasing or decreasing; (4) a motor, which may be configured to move the sample and/or spectrometer assembly in the Z-direction to maintain a constant spatial distance between the sample and the spectrometer; and (5) one or more position sensors communicatively coupled to the computing device and the motor, which may be configured to determine the distance between the sample and spectrometer. In some embodiments, the system is able to maintain a constant spatial distance between the sample and spectrometer irrespective of local sample topography, so as to ensure that all XRF pixel spectra are directly comparable to one another for a given sample measurement area.

According to the present disclosure, the disadvantages of the prior art are overcome or at least reduced by an XRF spectrometer system that is configured for mapping or imaging XRF emitted by a high topology sample in response to incident X-ray radiation. The XRF (e.g., micro-XRF or meso-XRF) spectrometer system may incorporate an XY-stage to create elemental map images. The XRF spectrometer system may also include a motor for real-time control the spectrometer to sample surface distance in the Z-axis as the XY-stages scan or otherwise image an irregular sample surface. For example, the systems and methods described herein may facilitate a change of the sample to spectrometer distance in the Z-axis in mere milliseconds after detecting a change in the sample surface, effectively maintaining a constant distance in the Z-axis. Maintaining a constant Z-distance from spectrometer to sample maintains the diameter of the X-ray spot on the sample as a constant, thus creating a sharper and more consistent image, which provides superior quantitative and qualitative analyses from pixel to pixel.

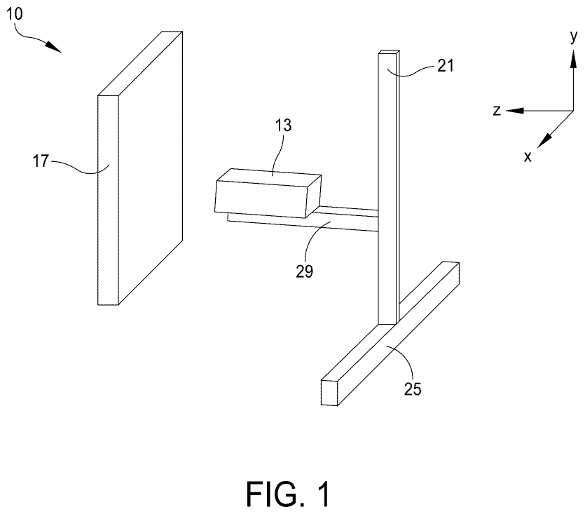

Referring now to the figures, FIG. 1 illustrates one example of an XRF spectrometer system 10 with a spectrometer 13 mounted to a Cartesian geometry set of stages in accordance with some embodiments. Some XRF analyzers and methods of analyzing a sample are disclosed in U.S. Pat. Nos. 6,108,398; 7,653,174; and U.S. Patent Application Publication No. 2014/0286473, the entireties of which are herein incorporated by reference. XRF techniques are further disclosed in “X-Ray Microfluorescence Analysis Inside and Outside the Electron Microscope” by I. Pozsgai, X-Ray Spectrometry, Volume 20, Issue 5, October 1991, Pages 215-223 and “Element Mapping by X-Ray Fluorescence Spectrometry” by Yoshinori Kobayashi et al., Analytical Sciences, Volume 1, April 1985, Pages 13-17, the entireties of which are incorporated herein by reference.

The spectrometer 13 may be mounted on a Cartesian geometry set, such as a moveable set of stages. The spectrometer 13 may include motorized high precision linear stages situated adjacent to a sample 17. For example, spectrometer 13 is capable of scanning for XRF by movements of the spectrometer 13 on a Y-stage 21, X-stage 25, and/or Z-stage 29. One of ordinary skill in the art will understand that the X-stage 25, Y-stage 21, and Z-stage 29 travel may be otherwise configured to allow for the necessary travel to support the desired application.

The Z-stage 29 may be operatively linked to one or more position sensors located proximate the spectrometer 13, such as position sensors 215 as will be described in more detail below. The sensor data from the one or more position sensors may be used to maintain a uniform distance between the spectrometer 13 and the sample 17, resulting in a consistent illumination spot size on the sample 17 surface topography. Maintaining a constant distance between the spectrometer 13 and the sample 17 ensures a consistent illumination spot size on the sample 17 surface topography, which correlates to improved XRF analysis. The ability to provide a consistent illumination spot size for samples 17 that have irregular surface (e.g., not flat or smooth surfaces) advantageously improves the XRF analysis of such samples.

A computing device, such as computing device 211 and 300 described in further detail below, may be communicatively coupled to the spectrometer 13 and one or more of the stages, e.g., the X-stage 25, Y-stage 21, and/or Z-stage 29. The computing device may be configured to perform computational assessments of specific elements of spectrometric data that correlate with the distance between the sample 17 and the spectrometer 13. The spectral data received by the XRF spectrometer system 10 during a mapping scan may be compared/contrasted with the preceding spectral data to identify changes in proximity of distinct surface features of the sample 17 relative to the spectrometer 13. Based on the identification of changes of spectral data, the computing device may adjust the position of a stage, e.g., the Z-stage 29, facilitated by a motor, such as motor 219 described in more detail below, to retain an optimal and/or desired distance for collection between the spectrometer 13 and the sample 17. Distance correction methods for XRF techniques are disclosed in “A distance correction method for improving the accuracy of particle coal online X-ray fluorescence analysis—Part 1: Theoretical dependence of XRF intensity on the distance” by Yan Zhang et al., Radiation Physics and Chemistry, Volume 147, June 2018, Pages 118-121, the entirety of which is incorporated herein by reference.

In some embodiments, scanning modalities for the XRF spectrometer system 10 may include raster, sinusoidal, rotational, spiral, cycloid, and Lissajous, to list only a few, non-limiting possibilities. In some embodiments, other non-Cartesian stage configurations may be employed, such as an r-Θ mechanism. As an example, an r-Θ mechanism may include a translation stage with an arm that is configured to move the spectrometer 13 in an angular direction (Θ) while translating the arm along a r-axis from the origin in a polar coordinate system simultaneously. Meaning the r-Θ mechanism could effectively replace the X-stage 25 and the Y-stage 21 of the XRF spectrometer system 10. In this embodiment, the XRF spectrometer system 10 would include the translation stage configured to move the arm in the angular direction (Θ) and translate the arm along the r-axis, as well as a Z-stage 29 configured to change the distance between the spectrometer 13 and the sample 17 as discussed above.

In some embodiments, the spectrometer 13 and associated XRF spectrometer system 10 may be mounted onto a caster assembly that allows the system 10 to be transported and/or repositioned. The caster assembly may be motorized to afford a self-transporting system and to allow for fine adjustments to positioning at the measurement site. Instruments for in situ scanning and mapping of XRF are disclosed in commonly owned U.S. patent application Ser. No. 18/968,620 filed on Dec. 4, 2024 entitled “Systems and Methods for Mobile Elemental Analysis,” the entirety of which is incorporated herein by reference.

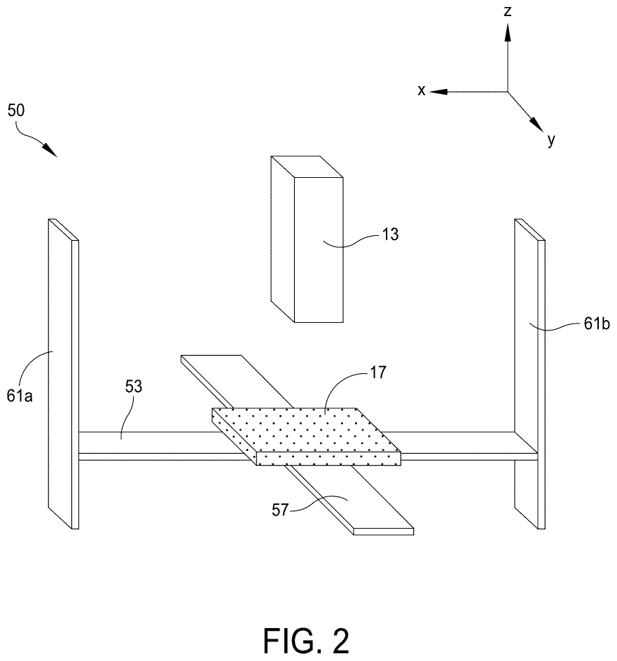

FIG. 2 illustrates one example of an XRF spectrometer system 50 with a sample 17 mounted to an XYZ-stage in accordance with some embodiments. The XRF spectrometer system 50 may include a spectrometer 13 may be fixed proximate to the sample 17. In this embodiment, the sample 17 (not the spectrometer 13) may be mounted on a motorized stage assembly having an X-stage 53, a Y-stage 57, and one or more Z-stages 61a-b. The X-stage 53 and the Y-stage 57 may be configured to move the spectrometer 13 to scan the sample 17 for XRF mapping.

The Z-stages 61a-b may be operatively linked to one or more position sensors located proximate the spectrometer 13, such as position sensors 215 as will be described in more detail below. The sensor data from the one or more position sensors may be used to maintain a uniform distance between the spectrometer 13 and the sample 17 resulting in a consistent illumination spot size on the sample 17 surface topography. As noted above, maintaining a constant distance between the spectrometer 13 and the sample 17 ensures a consistent X-ray illumination spot size on the sample 17 surface topography, which enables improved XRF analysis compared to fixed stage/sample arrangements when the samples have irregular surfaces (e.g., not flat or smooth surfaces). In some embodiments, a computing device, such as computing device 211 or 300 described in more detail below, may be communicatively coupled to the spectrometer 13 and the Z-stages 61a-b. The computing device may be adapted to perform computational examinations of specific aspects of the received spectrometric data from the spectrometer 13 that correspond to the distance between the sample 17 and the spectrometer 13. For example, the spectral data may be assessed in relation to the immediately preceding spectral data to ascertain any changes in proximity of specific surface features of the sample 17 relative to the spectrometer 13. Based at least in part on the assessment of the spectral data, the computing device may adjust the position of the Z-stages 61a-b by a motor, such as the motor 219 described in more detail below, to maintain the desired distance between the spectrometer 13 and the sample 17.

For example, spectrometer 13 is capable of scanning for XRF mapping by movements of the sample on a Y-stage 57, X-stage 53, and/or Z-stages 61a-b. One of ordinary skill in the art will understand that the X-stage 53, Y-stage 57, and Z-stages 61a-b travel may be otherwise configured for the necessary travel to support the desired application. In some embodiments, scanning modalities for the XRF spectrometer system 50 may include raster, sinusoidal, rotational, spiral, cycloid, and Lissajous, to list only a few, non-limiting possibilities. In some embodiments, other non-Cartesian stage configurations may be employed, such as an r-Θ mechanism having a stage with an arm that is configured to move the sample 17 in an angular direction (Θ) while simultaneously translating the sample 17 along a r-axis from the origin in a polar coordinate system. Meaning the r-Θ mechanism could effectively replace the X-stage 53 and the Y-stage 57 of the XRF spectrometer system 50. In this embodiment, the XRF spectrometer system 50 would include the translation stage configured to move the arm in the angular direction (Θ) and translate the arm along the r-axis, as well as Z-stages 61a-b configured to change the distance between the spectrometer 13 and the sample 17 as discussed above.

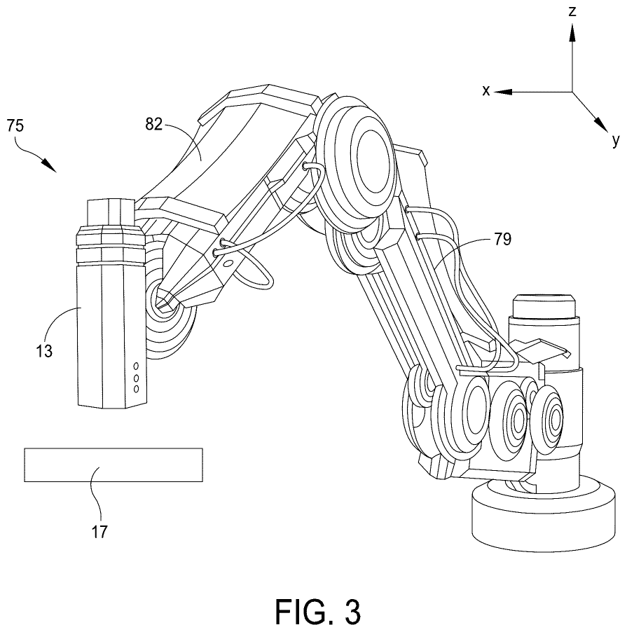

FIG. 3 illustrates one example of an XRF spectrometer system 75 incorporating a robot 79 in accordance with some embodiments. The XRF spectrometer system 75 may include the spectrometer 13 configured as an end effector of a multi-axis industrial robot 79. For example, the spectrometer 13 may be coupled to an arm 82 of the robot 79. The robotic arm 82 may be configured to move in X, Y, and Z directions as described above with reference to XRF spectrometer systems 10 and 50. In some embodiments, the robotic arm 82 may include r-Θ motion capabilities for XRF mapping as discussed with reference to XRF spectrometer systems 10 and 50 above. The robotic arm 82 may have the ability to adjust the spectrometer 13 in the X, Y, and Z-axes to maintain a consistent distance between the spectrometer 13 and a sample 17 to ensure a constant illumination spot size on the sample 17 surface topography.

The robotic arm 82 may be operatively linked to one or more position sensors located proximate the spectrometer 13, such as position sensors 215 as will be described in more detail below. The sensor data from the one or more position sensors may be used to maintain a uniform distance between the spectrometer 13 and the sample 17 resulting in a consistent illumination spot size on the sample 17 surface topography. Maintaining a constant distance between the spectrometer 13 and the sample 17 may ensure a consistent illumination X-ray spot size on the sample 17 surface topography, which is advantageous for samples that have an irregular surface (e.g., not flat or smooth surfaces) as it enables improved XRF analysis.

A computing device, such as computing device 211 and 300 described in further detail below, may be communicatively coupled to the spectrometer 13 and robot 79. The computing device may be configured to perform computational assessments of specific elements of spectrometric data that correlate with the distance between the sample 17 and the spectrometer 13. The spectral data received by the XRF spectrometer system 75 during a mapping scan may be compared/contrasted with the preceding spectral data to identify changes in proximity of distinct surface features of the sample 17 relative to the spectrometer 13. Based at least in part on the assessment of the spectral data, the computing device may provide Z-axis position corrections to the robot 79 by a motor, such as the motor 219 described in more detail below, to uphold the desired distance between the spectrometer 13 and the sample 17.

Scanning modalities for the XRF spectrometer system 75 may include raster, sinusoidal, rotational, spiral, cycloid, and Lissajous, to list only a few, non-limiting possibilities. In some embodiments, other non-Cartesian stage configurations may be employed, such as an r-Θ mechanism. As an example, the robot 79 having an arm may be configured to move the spectrometer 13 in an angular direction (Θ) while simultaneously translating the spectrometer 13 along a r-axis from the origin in a polar coordinate system. In this embodiment, the position of the spectrometer 13 can be transformed mathematically back into the Cartesian space to determine a position of the spectrometer 13 along the X and Y axes if desired.

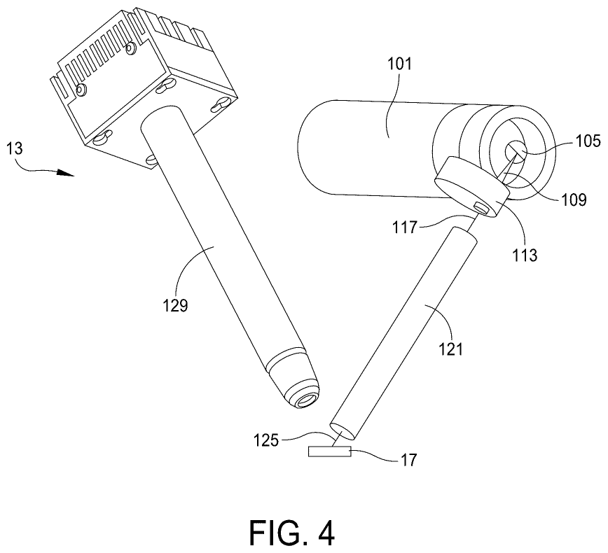

FIG. 4 illustrates aspects of an exemplary spectrometer 13 in accordance with some embodiments. The spectrometer 13 may be configured for meso-XRF or micro-XRF analysis, to list only a couple of non-limiting possibilities. The spectrometer 13 may include one or more X-ray tubes 101 having an anode 105 configured to emit a divergent primary X-ray beam 109. In a first approximation, the anode 105 resembles a point source. The spectrometer 13 may also include a filtering foil system 113 operatively coupled to the X-ray tube 101. The filtering foil system 113 may be configured as a motorized revolving wheel, as illustrated in FIG. 4, having multiple filtering materials. In some embodiments, the filtering foil system 113 may be a linear translation device having a plurality of filtering materials. The filtering materials may be made of materials such as metal, plastic, doped plastic coupons, or stacked foils of varying thicknesses. The filtering foil system 113 may be configured to modify the primary X-ray beam 109 to produce a divergent X-ray beam 117 having a modified continuum.

The spectrometer 13 may also include an optical system 121, such as a capillary (or polycapillary) lens or a multi-pinhole optical train. The optical system 121 may receive the divergent X-ray beam 117 and project a micro-scale or meso-scale beam 125 onto the surface of a sample 17. Examples of an XRF spectrometer optical and aperture system are disclosed in U.S. Pat. No. 10,908,103, the entirety of which is incorporated herein by reference. Focusing polycapillary lenses are disclosed in “Focusing Polycapillary Optics and Their Applications” by Carolyn A. MacDonald, X-Ray Optics and Instrumentation, Volume 2010, Article ID 867049, the entirety of which is incorporated herein by reference. Pinhole collimation optics are disclosed in “Advancements in Portable and Lab Based XRF Instrumentation for Analysis in Cultural Heritage: A Change in Perspective” by Aaron Shugar, Microscopy and Microanalysis, Volume 27, Issue S1, 1 Aug. 2021, Pages 2552-2553, the entirety of which is incorporated herein by reference.

In some embodiments, the sample 17 and/or the spectrometer 13 may be placed on a movable stage capable of positioning the sample 17 and/or spectrometer 13 in X-, Y-, and Z-directions. The XY-stage(s) may operate in the plane of the sample 17 and facilitate movement of the sample 17 and/or spectrometer 13 using some scanning or stepping modality as described above. The moveable stages may employ linear motor actuators, an r-Θ mechanism, or a multi-axis robotic system as described above regarding the XRF spectrometer systems 10, 50, and 75 described above. As an example, an r-Θ mechanism may include an arm and stage that is configured to move the sample 17 and/or spectrometer 13 in an angular direction (Θ) with simultaneous translation of the sample 17 or the spectrometer 13 along a r-axis of a polar coordinate system as discussed above.

The spectrometer 13 may also include one or more X-ray detectors 129 situated to measure characteristic X-ray fluorescence radiation emitted from the sample 17 in response to the incident X-rays and portions of the reduced cross-section incident X-ray beam 125 scattered or diffracted by the sample 17. The detector 129 may relay the associated detector signals to an electronic evaluation unit, such as electronic evaluation unit 207 described in further detail below, configured to be evaluated by the received XRF radiation from the sample 17. As described above, for enhanced mapping capability, the moveable stages may allow for movement in the Z-direction to adjust the sample 17 to spectrometer 13 distance, ensuring consistent distance from a sample 17 having an irregular surface.

The primary radiation, or divergent X-ray beam 117, emitted from the spectrometer 13 may be focused (and/or filtered) by optical system 121 or a collimator system. The beam 125 may then pass through some path, such as through air, gas (e.g., helium), or a vacuum. The beam 125 may then interact with the sample 17 before the resulting characteristic X-rays from the sample 17, along with scatter and other spectral artifacts, are recorded by the detector(s) 129 after passing through the path again. For the purpose of constant sample 17 to spectrometer 13 distance, the absolute intensity of the primary radiation may not be relevant. Source-to-sample distance considerations are disclosed in “Data intrinsic correction for working distance variations in MA-XRF of historical paintings based on the Ar signal” by Matthias Alfeld et al., X-ray Spectrometry, Volume 50, 2021, Pages 351-357, and “Source-to-sample distance independent efficiency technique for XRF analysis” by J. M. Maia et al., Applied Radiation and Isotopes, Volume 48, Issues 10-12, 1997, Pages 1649-1656, the entireties of which are incorporated herein by reference.

The recorded intensity of element I at some sample 17 to spectrometer 13 distance Iᵢ(d) is dependent on the path distance and may be given in Equation (1).

$${I}_{i ( d )} = \frac{Ω ( d )}{4 π} \cdot {A}_{i ( d )} \cdot {ϕ}_{i ( d )} \cdot {k}_{i} \qquad ( 1 )$$

Where:
1. Ω(d) is the solid angle at which the detector 129 is recording the X-ray fluorescence and scattered radiation from the beam 125 matter interaction;
2. Aᵢ(d) is the absorption of the fluorescence radiation in the path and is described in Equation (2) below;
3. ϕᵢ(d) is the quantum efficiency of the detector 129, as explained in Equation (3) below; and
4. kᵢ is an element specific constant used for normalization.

An approximation to calculate the solid angle (Ω(d)) is to divide the detector 129 active area by the sample 17 to detector 129 distance squared. Solid angle calculations for energy dispersive XRF detectors are disclosed in “Calculating the Detector Solid Angle in X-ray Energy Dispersive Spectroscopy” by Nestor J. Zaluzec, Microscopy and Microanalysis, Volume 15, Issue S2, Jul. 1, 2009, Pages 520-521, the entirety of which is incorporated herein by reference. Effects of air absorption of X-rays are disclosed in “Absorption of X-Ray in Air” by Frank H. Day et al., Journal of Research of the National Bureau of Standards, Volume 40, Research Paper RP1883, May 1948, Pages 393-399, the entirety of which is incorporated herein by reference. The absorption in the path may be modeled by Equation (2) below:

$${A}_{i ( d )} = {e}^{- d ρμ ( {E}_{pi} )} {e}^{- {d}_{eff} ρμ ( {E}_{fi} )} \qquad ( 2 )$$

Where:
1. d is the distance from X-ray source exit window to the sample 17;
2. d_{eff} is the distance from the sample 17 to the detector 129;
3. ρ is the density of air or gas in the path;
4. Eₚᵢ is the energy of the primary beam 109;
5. E_{fi} is the energy of the fluorescence radiation; and
6. μ is the energy dependent mass absorption coefficient.

Quantum efficiency of the detector 129 may be described by Equation (3) below:

$${ϕ}_{i ( d )} = 1 - {e}^{- {μ}_{Si} ( {E}_{fi} ) {d}_{Si} {ρ}_{Si} / sin ( α )} \qquad ( 3 )$$

Where:
1. d_{Si} is the thickness of the detector's 129 active volume;
2. μ_{Si} is the energy dependent mass absorption coefficient of the detector 129 material;
2. ρ_{Si} is the density of the detector 129 material (e.g., silicon);
3. E_{fi} is the energy of the X-ray fluorescence radiation; and
4. α is the angle between the surface of the detector 129 and the incoming X-ray fluorescence radiation from the sample 17.

For a given sample 17 and spectrometer 13 combination, examination of equations (1)-(3) show that all variables are constants except for the sample 17 to detector 129 distance (d), the resulting solid angle (Ω(d)) subtended by the detectors(s) 129, and the density (ρ) of the environment. The intensity of any elemental peak or spectral artifact, corrected for the density of the measuring medium, will be negatively correlated to sample 17 to spectrometer 13 distance. This relationship is true regardless of measurement medium in the path, whether air, gas, or vacuum. Thus, this correlation, between intensity and sample 17 to spectrometer 13 distance, can be mathematically modeled from empirical data by employing a version of least squares fitting, resulting in a relationship that may be linear, quadratic, power, exponential, polynomial or some other function.

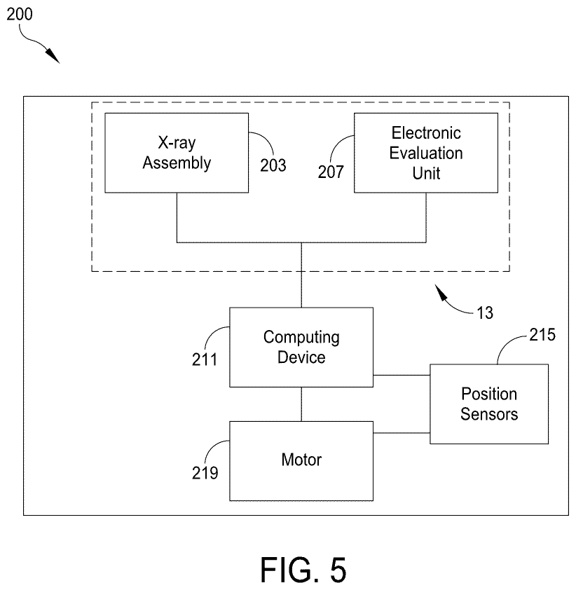

FIG. 5 illustrates one example of a block diagram of an exemplary spectrometer analysis system 200 configured to maintain a constant distance between a sample 17 surface and a spectrometer 13 in accordance with some embodiments. The spectrometer analysis system 200 may include a spectrometer 13 having one or more X-ray assemblies 203 and an electronic evaluation unit 207. The spectrometer analysis system 200 may also include one or more computing devices 211, one or more position (or proximity) sensors 215, and one or more motors 219. The spectrometer analysis system 200 may be configured to operate with a plurality of XRF spectrometer systems, such as XRF spectrometer system 10, 50, or 75 discussed above.

The X-ray assembly 203 may have one or more X-ray sources housed in X-ray tube 101 and one or more X-ray detectors 129. The X-ray assembly 203 may be configured to provide raw analogue energy dispersive XRF spectral information on a per-pixel basis. For example, the X-ray assembly 203 may be configured to determine the atmospheric density corrected count rate of spectral artifacts. The spectral artifacts may be one or more of: (1) any relatively invariant element(s) in the spectra from the sample 17; (2) any energy region within the spectra from a sample 17; (3) Rayleigh scatter from the X-ray source as reflected off the sample 17; (4) Compton scatter from the X-ray source as reflected off the sample 17; (5) Bremsstrahlung scatter from the X-ray source as reflected off the sample 17; (6) any ratio of elemental peaks or scatter peaks within the spectra from a sample 17; (7) argon (Ar) elemental peak from the air between the sample 17 and spectrometer 13 as observed in spectra from a sample 17 where an air path is employed; (8) a pure element or composite substrate placed beneath the sample 17 that is less than infinitely thick, providing a reference peak within the spectra from the sample 17; and (9) the entire spectrum, or overall count rate, in the spectra from the sample 17.

The electronic evaluation unit 207 may have a digital pulse processor(s) (DPP) coupled to the X-ray detectors 129 for digitizing electrical signals from the received X-rays. The electronic evaluation unit 207 may also include a multichannel analyzer(s) (MCA) adapted to categorize the energy of X-rays detected by the detector(s) 129, yielding an output of counts by X-ray energy per pixel, termed a pixel spectrum. The computing device 211, such as computing device 300 described in more detail below, may be communicatively coupled to the X-ray assembly 203 and the electronic evaluation unit 207. In some embodiments, computing device 211 may be a computer or a programmable logic controller (PLC). The computing device 211 may be configured to compare features of the most recent pixel spectrum to the same features in the preceding pixel spectrum to discern if changes in the sample 17 to spectrometer 13 distance is necessary. For example, the computing device 211 may be configured to associate the determined count rate of the spectral artifacts from the electronic evaluation unit 207 with a Z-axis distance between the spectrometer 13 and the sample 17 as described above.

Position sensors 215 may be communicatively coupled to the computing device 211 and a motor 219. The Z-stage (e.g., Z-stage 29, Z-stages 61a-b, or robot 79) may be communicatively coupled to the position sensors 215 located proximate to the spectrometer 13 through the motor 219. The position sensors 215 may provide distance data that is used by the computing device 211 and/or the motor 219 to move the spectrometer 13 or sample 17 to maintain a uniform distance between the spectrometer 13 and the sample 17. In some embodiments, the position sensors 215 may be one or more ultrasonic distance sensors with a >0.069 mm resolution and ±0.15% repeatability may be employed. However, a person of ordinary skill in the art will appreciate that other position sensors may be used.

The position sensors 215 may be used to measure the distance in the Z-axis. This measurement may be done in conjunction with the computing device 211 automatically measuring and setting absolute Z-stage 29, 61a-b or robot 79 coordinates for sample 17 to spectrometer 13 distance. This can be done at each rectangle vertex set point of a map based upon a value previously entered into the computing device 211 that is a function of the type of optical system 121. In some embodiments, the motor 219 may be driven by the computing device 211 to maintain a spectrometer 13 to sample 17 distance that corresponds to the Z value of a plane in Cartesian space extrapolated between the two set Cartesian points based on the assumption that point one (X1, Y2) uses the value of Z1 and point two (X2, Y1) uses the value of Z2. In some embodiments, the motor 219 may move the Z-stage 29, 61a-b or robot 79 in the Z-direction to maintain a spectrometer 13 to sample 17 distance that corresponds to the Z value of a plane in Cartesian space extrapolated between the two set Cartesian points based on the assumption that point one (X1, Y2) uses the value of Z2 and point two (X2, Y1) uses the value of Z1.

The motor 219 may include a Z-axis controller communicatively coupled to the computing device 211 and position sensors 215. The motor 219 may be operable to continuously adjust the position of either the sample 17 or the spectrometer 13 in the Z-direction to ensure a consistent spatial distance between the spectrometer 13 and the sample 17 having an irregular surface. For example, in the case of XRF spectrometer system 10 illustrated in FIG. 1, the Z-stage 29 may be configured to continuously adjust the spectrometer 13 in the Z-direction to maintain a constant distance in the Z-axis between the spectrometer 13 and the sample 17. As another example, in the case of XRF spectrometer system 50 illustrated in FIG. 2, the Z-stages 61a-b may be configured to continuously adjust the sample 17 in the Z-direction to maintain a constant distance in the Z-axis between the spectrometer 13 and the sample 17. In yet another example, in the case of the XRF spectrometer system 75 illustrated in FIG. 3, the robot 79 may be configured to continuously adjust the spectrometer 13 in the Z-direction to maintain a constant distance in the Z-axis between the spectrometer 13 and the sample 17.

The Z-stages 29, 61a-b or robot 79 may be driven by the computing device 211 through the motor 219 to maintain a spectrometer 13 to sample 17 distance that corresponds to the Z value of a plane in Cartesian space extrapolated between four Cartesian set points, such as a upper left, a lower left, an upper right, and a lower right set point of the sample 17. Movement of the Z-stage 29, 61a-b or robot 79 may facilitate a consistent illumination spot size on the sample 17 irrespective of surface topography.

The motor 219 may be any suitable motor configured to move one or more stages of the XRF spectrometer system 10, 50 or the robotic arm 82. For example, motor 219 may be a DC motor, an AC motor, or other special purpose motor such as a stepper motor, brushless motor, hysteresis motor, reluctance motor, universal motor, or servo motor just to provide a few non-limiting examples. In some embodiments, there may be one motor 219 that controls all stages of the XRF spectrometer system 10, 50. In other embodiments, there may be one motor 219 dedicated for each of the stages of the XRF spectrometer system 10, 50.

In some embodiments, the computing device 211 may be configured to perform computational assessments of specific aspects of spectrometric data that correlate with the distance between the sample 17 and the spectrometer 13 as described above. The spectral data received during a mapping scan may be contrasted with the preceding spectral data to identify changes in proximity of distinct surface features of the sample 17 relative to the spectrometer 13. Based at least in part on this identification, the computing device 211 adjusts the position of the Z-stages 29, 61a-b or robotic arm 82 through the motor 219 with the aid of position sensors 215 to retain the optimal and/or desired distance between the spectrometer 13 and the surface of the sample 17.

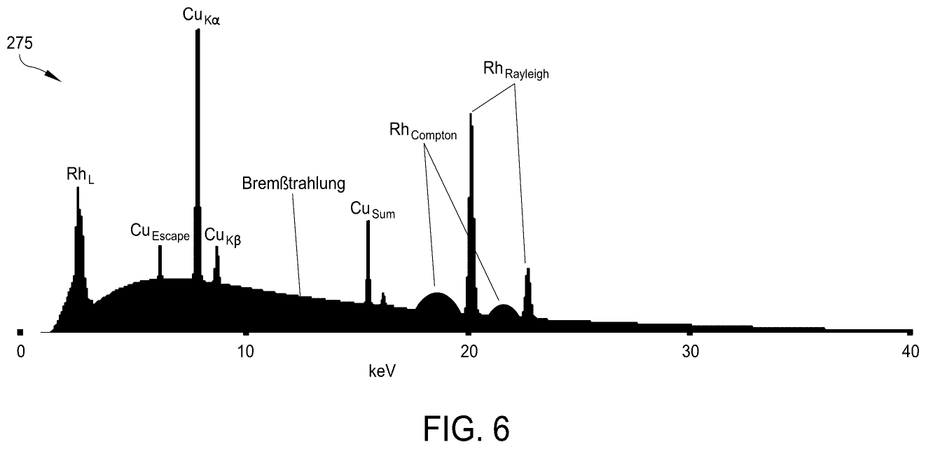

FIG. 6 illustrates one example of a plot 275 of a pixel spectrum after analysis by an XRF spectrometer system 10, 50, or 75 in accordance with some embodiments. Plot 275 illustrates the intensity of a pixel spectrum with spectral elements that can be used to track intertemporal changes on XRF spectra for maintaining a constant distance between the spectrometer 13 and sample 17. As an example, the plot 275 is illustrating a synthetic spectra which is simulating a rhodium (Rh)-anode X-ray tube 101 without a filter operating at 50 kV exciting a polymer sample containing copper (Cu). Plot 275 illustrates reflected Bremsstrahlung and the characteristic Rh Rayleigh (Rh_{Rayleigh}) and Compton (Rh_{Compton}) K-line scatter as well as the Rh L-line (Rh_{L}) scatter. From the copper (Cu) in the sample, we see the characteristic K-lines together with sum peaks (Cu_{Sum}) and escape peak (Cu_{Escape}) artifacts. As discussed above, the intensity of the elemental peaks and spectral artifacts can be modeled to determine the sample 17 to spectrometer 13 distance. The XRF spectrometer system (e.g., XRF spectrometer system 10, 50, or 75) can then be used to adjust the sample 17 or spectrometer 13 as needed in real-time to maintain a constant distance in the Z-axis.

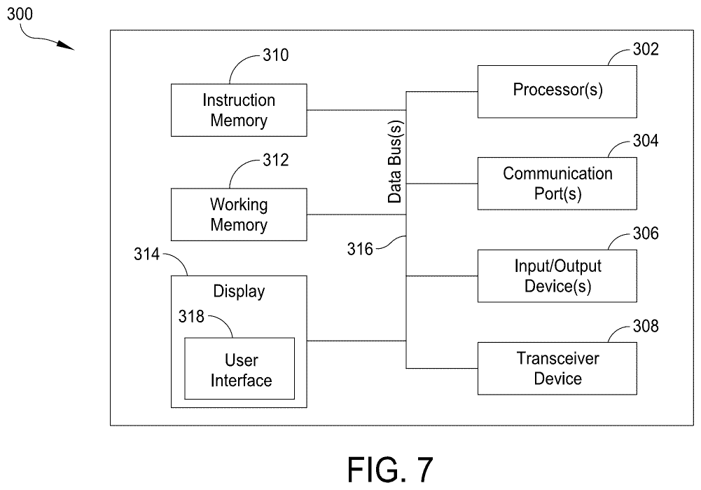

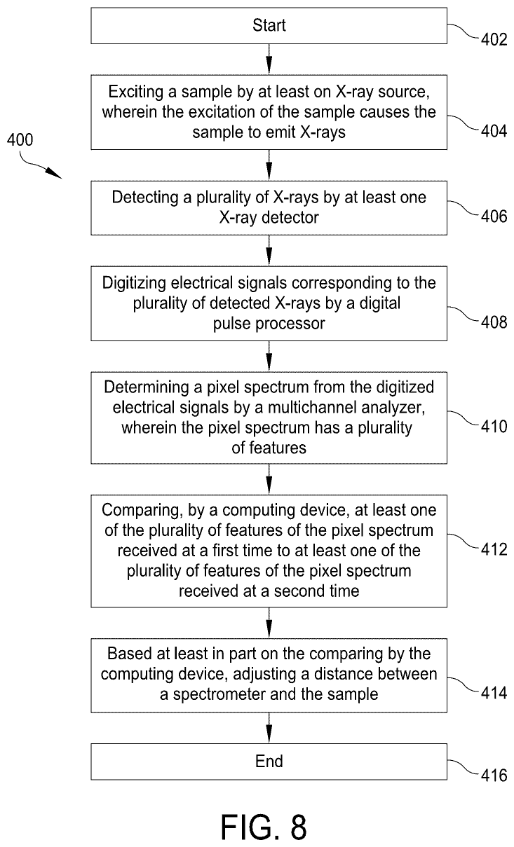

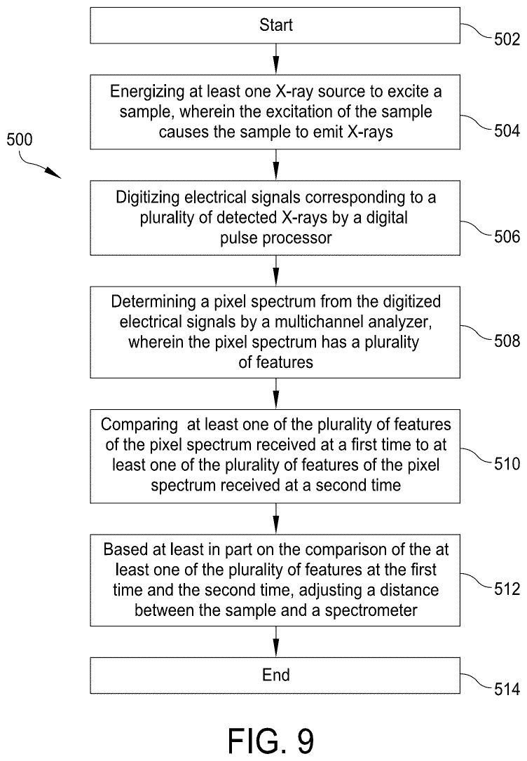

FIG. 7 illustrates one example of a block diagram of an exemplary computing device 300 of an XRF spectrometer system (e.g., XRF spectrometer system 10, 50, or 75) in accordance with some embodiments. The computing device 300 can be employed by a disclosed system or used to execute a method of the present disclosure. For example, computing device 300 may be computing device 211 or any other computing device described herein. Computing device 300 may be configured to operate any of the systems illustrated in FIGS. 1-5 and/or to perform the methods illustrated in FIGS. 8-9. It should be understood, however, that other computing device configurations (e.g., multiple and/or distributed configurations) are possible.

Computing device 300 can include one or more processors 302, one or more communication port(s) 304, one or more input/output devices 306, a transceiver device 308, instruction memory 310, working memory 312, and optionally a display 314, all operatively coupled to one or more data buses 316. Data buses 316 allow for communication among the various devices, processor(s) 302, instruction memory 310, working memory 312, communication port(s) 304, and/or display 314. Data buses 316 can include wired, or wireless, communication channels. Data buses 316 are connected to one or more devices.

Processor(s) 302 can include one or more distinct processors, each having one or more cores. Each of the distinct processors 302 can have the same or different structures. Processor(s) 302 can include one or more central processing units (CPUs), one or more graphics processing units (GPUs), application specific integrated circuits (ASICs), digital signal processors (DSPs), and the like.

Processor(s) 302 can be configured to perform a certain function or operation by executing code, stored on instruction memory 310. For example, processor(s) 302 can be configured to perform one or more of any function, method, or operation disclosed herein.

Communication port(s) 304 can include, for example, a serial port such as a universal asynchronous receiver/transmitter (UART) connection, a Universal Serial Bus (USB) connection, or any other suitable communication port or connection. In some examples, communication port(s) 304 allows for the programming of executable instructions in instruction memory 310. In some examples, communication port(s) 304 allow for the transfer, such as uploading or downloading, of data. In some embodiments, a wired or wireless fieldbus or Modbus protocol may be used.

Input/output devices 306 can include any suitable device that allows for data input or output. For example, input/output devices 306 can include one or more of a keyboard, a touchpad, a mouse, a stylus, a touchscreen, a physical button, a speaker, a microphone, or any other suitable input and/or output device.

Transceiver device 308 can allow for communication with a network, such as a Wi-Fi network, an Ethernet network, a cellular network, radio signals, Bluetooth, or any other suitable communication network. For example, if operating in a cellular network, transceiver device 308 is configured to allow communications with the cellular network. Processor(s) 302 is operable to receive data from, or send data to, a network via transceiver device 308.

Instruction memory 310 can include an instruction memory 310 that can store instructions that can be accessed (e.g., read) and executed by processor(s) 302. For example, the instruction memory 310 can be a non-transitory, computer-readable storage medium such as a read-only memory (ROM), an electrically erasable programmable read-only memory (EEPROM), flash memory, a removable disk, CD-ROM, any non-volatile memory, or any other suitable memory with instructions stored thereon. For example, the instruction memory 310 can store instructions that, when executed by one or more processors 302, cause one or more processors 302 to perform one or more of the operations of the XRF spectrometer system 10, 50, 75 and/or spectrometer analysis system 200.

In addition to instruction memory 310, the computing device 300 can also include a working memory 312. Processor(s) 302 can store data to, and read data from, the working memory 312. For example, processor(s) 302 can store a working set of instructions to the working memory 312, such as instructions loaded from the instruction memory 310. Processor(s) 302 can also use the working memory 312 to store dynamic data created during the operation of computing device 300. The working memory 312 can be a random access memory (RAM), such as a static random access memory (SRAM), or dynamic random access memory (DRAM), or any other suitable memory.

Display 314 is configured to display user interface 318. User interface 318 can enable user interaction with computing device 300. In some examples, a user can interact with user interface 318 by engaging input/output devices 306. In some examples, display 314 can be a touchscreen, where user interface 318 is displayed on the touchscreen.

FIG. 8 illustrates a block diagram of an exemplary method 400 of XRF analysis in accordance with some embodiments. The method 400 may start at block 402. The method may include block 404 comprising exciting a sample 17 by at least one X-ray source, wherein the excitation of the sample 17 causes the sample to emit X-rays. The method 400 may include block 406 comprising detecting a plurality of X-rays by at least one X-ray detector 129. The method 400 may include block 408 comprising digitizing electrical signals corresponding to the plurality of detected X-rays by a digital pulse processor (“DPP”). The method 400 may include block 410 comprising determining a pixel spectrum from the digitized electrical signals by a multichannel analyzer, wherein the pixel spectrum has a plurality of features. The method 400 may include block 412 comprising comparing/contrasting, by a computing device 211, 300, at least one of the plurality of features of the pixel spectrum received at a first time to at least one of the plurality of features of the pixel spectrum received at a second time. The method 400 may include block 414 comprising based at least in part on the comparing/contrasting by the computing device 211, 300, adjusting a distance between a spectrometer 13 and the sample 17. The method 400 may end at block 416.

In some embodiments, the method 400 may include adjusting at least one of the spectrometer 13 or the sample 17 in an X-direction or a Y-direction. The distance between the spectrometer 13 and the sample 17 may be in a Z-direction. In some embodiments, the method 400 may include moving the spectrometer 13 or the sample 17 in an angular direction. In some embodiments, movement of the spectrometer 13 or the sample 17 in the angular direction may be in one of a raster, a sinusoidal, a rotational, a spiral, a cycloid, or a Lissajous pattern. In some embodiments, the adjustment of the distance between the spectrometer 13 and the sample 17 may be facilitated by one or more position sensors 215 configured to provide a signal used by one or more motors to maintain a consistent distance between the spectrometer 13 and the sample 17. In some embodiments, the spectrometer 13 or the sample 17 may be coupled to one or more Z-stages 29, 61a-b or a robotic arm 82.

The XRF spectrometer systems 10, 50, 75 disclosed herein may include a non-transitory computer readable medium having instructions stored thereon. The instructions, when executed by at least one processor (e.g., processor 302), cause a computing device (e.g., computing device 211, 300) to perform one or more operations 500. FIG. 9 illustrates a block diagram of exemplary operations 500 of XRF analysis in accordance with some embodiments. The operations 500 may start at block 502. The operations 500 may include block 504 comprising energizing at least one X-ray source to excite a sample 17, wherein the excitation of the sample 17 causes the sample 17 to emit X-rays. The method 500 may include block 506 comprising digitizing electrical signals corresponding to a plurality of detected X-rays by a digital pulse processor. The operations 500 may include block 508 comprising determining a pixel spectrum from the digitized electrical signals by a multichannel analyzer, wherein the pixel spectrum has a plurality of features. The operations 500 may include block 510 comprising comparing/contrasting at least one of the plurality of features of the pixel spectrum received at a first time to at least one of the plurality of features of the pixel spectrum received at a second time. The operations 500 may include block 512 comprising based at least in part on the comparing/contrasting of the at least one of the plurality of features at the first time and the second time, adjusting a distance between the sample 17 and a spectrometer 13. The operations 500 may end at block 514.

In some embodiments, the operations 500 may include adjusting at least one of the spectrometer 13 or the sample 17 in an X-direction or a Y-direction. The distance between the spectrometer 13 and the sample 17 may be in a Z-direction. In some embodiments, the operations 500 may include moving the spectrometer 13 or the sample 17 in an angular direction. In some embodiments, the movement of the spectrometer 13 or the sample 17 in the angular direction may be in one of a raster, a sinusoidal, a rotational, a spiral, a cycloid, or a Lissajous pattern. In some embodiments, the adjustment of the distance between the spectrometer 13 and the sample 17 is facilitated by one or more position sensors 215 configured to provide a signal used by one or more motors to maintain a consistent distance between the spectrometer 13 and the sample 17. In some embodiments, the spectrometer 13 or the sample 17 is coupled to one or more Z-stages 29, 61a-b or a robotic arm 82.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A spectrometer analysis system comprising:
a spectrometer including:
an X-ray assembly with one or more X-ray sources and one or more X-ray detectors, and
an electronic evaluation unit communicatively coupled to the X-ray assembly and configured to:
digitize electrical signals of a plurality of X-rays received by the one or more X-ray detectors; and
determine a pixel spectrum having a plurality of features;
a computing device communicatively coupled to the X-ray assembly and the electronic evaluation unit, wherein the computing device is configured to compare at least one of the plurality of features of the pixel spectrum received at a first time to at least one of the plurality of features of the pixel spectrum received at a second time; and
one or more motors communicatively coupled to the computing device and configured to adjust a distance between a sample and the spectrometer based at least in part on the comparing by the computing device.

2. The spectrometer analysis system of claim 1, wherein the one or more motors are further configured to move at least one of the sample or the spectrometer in an X-direction and a Y-direction.

3. The spectrometer analysis system of claim 2, wherein the spectrometer is coupled to a Z-stage configured to move in a Z-direction.

4. The spectrometer analysis system of claim 2, wherein the sample is coupled to at least one Z-stage configured to move in a Z-direction.

5. The spectrometer analysis system of claim 1, wherein the distance between the sample and the spectrometer is in a Z-direction.

6. The spectrometer analysis system of claim 1, wherein a scanning modality of the spectrometer or the sample is in one of a raster, a sinusoidal, a rotational, a spiral, a cycloid, or a Lissajous pattern.

7. The spectrometer analysis system of claim 1, wherein the spectrometer is coupled to a robotic arm.

8. The spectrometer analysis system of claim 1, further comprising one or more position sensors configured to provide a signal used by the one or more motors to maintain a consistent distance between the spectrometer and the sample.

9. A method of XRF analysis, comprising:
exciting a sample by at least one X-ray source, wherein the excitation of the sample causes the sample to emit X-rays;
detecting a plurality of X-rays by at least one X-ray detector;
digitizing electrical signals corresponding to the plurality of detected X-rays by a digital pulse processor;
determining a pixel spectrum from the digitized electrical signals by a multichannel analyzer, wherein the pixel spectrum has a plurality of features;
comparing, by a computing device, at least one of the plurality of features of the pixel spectrum received at a first time to at least one of the plurality of features of the pixel spectrum received at a second time; and
based at least in part on the comparing by the computing device, adjusting a distance between a spectrometer and the sample.

10. The method of claim 9, further comprising adjusting at least one of the spectrometer or the sample in an X-direction or a Y-direction, wherein the distance between the spectrometer and the sample is in a Z-direction.

11. The method of claim 9, further comprising moving the spectrometer or the sample in an angular direction.

12. The method of claim 11, wherein the movement of the spectrometer or the sample is in one of a raster, a sinusoidal, a rotational, a spiral, a cycloid, or a Lissajous pattern.

13. The method of claim 9, wherein the adjustment of the distance between the spectrometer and the sample is facilitated by one or more position sensors configured to provide a signal used by one or more motors to maintain a consistent distance between the spectrometer and the sample.

14. The method of claim 9, wherein the spectrometer or the sample is coupled to one or more Z-stages or a robotic arm.

15. A non-transitory computer readable medium having instructions stored thereon, wherein the instructions, when executed by at least one processor, cause a computing device to perform operations comprising:
energizing at least one X-ray source to excite a sample, wherein the excitation of the sample causes the sample to emit X-rays;
digitizing electrical signals corresponding to a plurality of detected X-rays by a digital pulse processor;
determining a pixel spectrum from the digitized electrical signals by a multichannel analyzer, wherein the pixel spectrum has a plurality of features;
comparing at least one of the plurality of features of the pixel spectrum received at a first time to at least one of the plurality of features of the pixel spectrum received at a second time; and
based at least in part on the comparison of the least one of the plurality of features at the first time and the second time, adjusting a distance between the sample and a spectrometer.

16. The non-transitory computer readable medium of claim 15, further comprising adjusting at least one of the spectrometer or the sample in an X-direction or a Y-direction, wherein the distance between the spectrometer and the sample is in a Z-direction.

17. The non-transitory computer readable medium of claim 15, further comprising moving the spectrometer or the sample in an angular direction.

18. The non-transitory computer readable medium of claim 17, wherein the movement of the spectrometer or the sample is in one of a raster, a sinusoidal, a rotational, a spiral, a cycloid, or a Lissajous pattern.

19. The non-transitory computer readable medium of claim 15, wherein the adjustment of the distance between the spectrometer and the sample is facilitated by one or more position sensors configured to provide a signal used by one or more motors to maintain a consistent distance between the spectrometer and the sample.

20. The non-transitory computer readable medium of claim 15, wherein the spectrometer or the sample is coupled to one or more Z-stages or a robotic arm.
